(19) United States
(12) Patent Application Publication
(10) Pub. No.: US 2009/0200377 A1
(43) Pub. Date: Aug. 13, 2009

(54) APPARATUS FOR RESOLVING CODE, APPARATUS FOR PROVIDING CODE INFORMATION AND THE METHOD THEREOF

(75) Inventors: Jun-Seob Lee, Daejeon-city (KR); Sang-Keun Yoo, Daejeon-city (KR); Yong-Woon Kim, Youngin-si (KR); Hyoung-Jun Kim, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTIT, Daejeon-city (KR)

(21) Appl. No.: 12/281,855

(22) PCT Filed: Oct. 31, 2006
(86) PCT No.: PCT/KR2006/004486

§ 371 Date: Sep. 5, 2008

(30) Foreign Application Priority Data
Mar. 7, 2006 (KR) 10-2006-0021289

(51) Int. Cl. G06K 7/01

(52) U.S. Cl. 235/440

(57) ABSTRACT

Provided are an apparatus for resolving a code, an apparatus for providing code information, and methods used by the apparatuses, which can resolve various codes recorded in a storage medium, such as a radio frequency identification (RFID) tag, or which can obtain content corresponding to the codes. The apparatus for resolving a code comprises a reader which reads an object identifier and a code; a transceiver which transmits information about the object identifier and receives code information required for resolving the code, which is provided in response to the transmitted information; and a resolver which resolves the read code based on the received code information.

### TECHNICAL FIELD

The present invention relates to an apparatus and method for resolving various codes stored in an electronic storage medium, such as radio frequency identification (RFID) tags, or codes stored in a physical storage medium, such as two-dimensional bar codes.

### BACKGROUND ART

Recently, technologies for attaching a radio frequency identification (RFID) tag (hereinafter, referred to as an electronic tag) containing a two-dimensional bar code or identification information to an object, reading the two-dimensional bar code or the identification information using a reader, and processing the two-dimensional bar code or the identification information by transmitting it to an information processing system, such as a host computer, through a wire/wireless network are rapidly improving.

The reader, such as an RFID reader, reads codes recorded in a storage medium, converts the codes into a uniform resource name (URN) or a fully qualified domain name (FQDN), and transmits the converted codes to a domain name system (DNS) server, in order to obtain various contents corresponding to the codes in the storage medium.

An object identifier is information showing the type of information recorded in the storage medium. The International Organization for Standardization (ISO) standardizes object identifiers to be recorded on the storage medium, such as the electronic tag, in order to show the type of the identifier.

In a conventional system, the reader reads the object identifier recorded in the storage medium and processes the object identifier only when the code can be converted into a URN or a FQDN. That is, the whole system including the reader can only process a code which is identified as a certain object identifier. Also, even if the reader is produced so as to resolve various types of codes, it cannot resolve a code that is newly generated after the reader is produced.

Accordingly, a method of resolving a code by detecting a type or a form of the code recorded in the storage medium by analyzing a bit structure of the code read from the storage medium has been introduced. However, even when the types or the forms of the codes are different, they may have the same bit structure. So a malfunction might occur using this method.

Thus, a reader which can read and process various types of codes recorded in the storage medium is required.

### DETAILED DESCRIPTION OF THE INVENTION

### Technical Problem

The present invention provides an apparatus for resolving a code, an apparatus for providing code information, and methods used by the apparatuses, which can resolve various codes recorded in an electronic storage medium, such as radio frequency identification (RFID) tags, or codes recorded in a physical storage medium, such as two-dimensional bar codes.

### Technical Solution

According to an aspect of the present invention, there is provided an apparatus for resolving a code, the apparatus including: a reader which reads an object identifier and a code; a first transceiver which transmits information about the object identifier and receives code information required for resolving the code, which is provided in response to the transmitted information; and a resolver which resolves the read code based on the received code information.

According to an aspect of the present invention, there is also provided an apparatus for providing code information, the apparatus including: a code information storage unit which stores code information required to resolve codes, corresponding to each object identifier; and a code information providing unit which provides code information corresponding to an object identifier received from an external device or location information of the code information with the external device.

According to an aspect of the present invention, there is also provided a method of resolving a code, the method including: reading an object identifier and a code; transmitting information about the object identifier and receiving code information required in resolving the code, which is provided in response to the transmitted information; and resolving the read code based on the received code information.

According to an aspect of the present invention, there is also provided a method of providing code information, the method including: storing code information required in resolving codes, corresponding to each object identifier; and providing code information corresponding to an object identifier received from an external device, to the external device.

### ADVANTAGEOUS EFFECTS

According to the present invention, codes recorded in a storage medium, such as radio frequency identification (RFID) tags based on various code systems, can be resolved in order to be used in various applications, and a code complying with a code system that is newly added after an RFID reader is manufactured can be resolved.

Also, a burden of providing information can be reduced and the information can be efficiently provided by hierarchically storing and providing information required in resolving a code.

### DESCRIPTION OF THE DRAWINGS

FIG. 1 is a diagram illustrating a structure of a storage medium according to an embodiment of the present invention;

FIG. 2 is a conceptual diagram illustrating processes of resolving a code according to an embodiment of the present invention;

FIG. 3 is a block diagram illustrating an apparatus for resolving a code illustrated in FIG. 2 according to an embodiment of the present invention;

FIG. 4 is a block diagram illustrating an apparatus for providing code information illustrated in FIG. 2 according to an embodiment of the present invention;

FIGS. 5A and 5B are block diagrams illustrating an apparatus for providing code information illustrated in FIG. 2 according to other embodiments of the present invention;

FIG. 6 is a flowchart illustrating a method of resolving a code according to an embodiment of the present invention; and

FIG. 7 is a flowchart illustrating a method of resolving a code according to another embodiment of the present invention.

### MODE OF THE INVENTION

Hereinafter, the present invention will be described more fully with reference to the accompanying drawings, in which exemplary embodiments of the invention are shown.

Examples of a storage medium that can be applied in the present invention include a electronic storage medium, such as a radio frequency identification (RFID) tag, and a physical storage medium, such as a two-dimensional bar code, but are not limited thereto, and any storage medium having recorded thereon an object identification and a code can be applied. For convenience, the present invention will be described with reference to an RFID system.

In an RFID system, a code is formed of numbers identifying a certain item or a combination of numbers and letters. Here, the code can be generally classified as a classification code, an identification code, or an attribute code. The classification code contains information which groups several similar items into a common category, the identification code is a code given to uniquely identify a particular object, and the attribute code is a code granting an attribute to a product in order to infer properties of the product.

In the RFID system, the code is used to identify only an object to which the RFID tag is attached. Accordingly, an RFID code is classified as an identification code. In a system using RFID, additional information may be added to the code in order to include classification or attribute information in the code, but the code in the RFID system is substantially used for identification. Classification or attribute information can be obtained through a query to another server, using the identification information. Even when the code includes information through which the classification or attribute information of an object can be detected, generally, assistance from other applications is required in order to resolve the classification or attribute information.

In order to resolve the RFID code into exact information having a particular meaning, antecedent or additional information is required. Externally, the RFID code is only a binary bit string formed of “0”s and “1”s, and thus nothing can be obtained from the RFID code itself. Accordingly, in order for the binary to have some meaning, additional information about what the binary means is required. For example, if information about the binary includes information about a unique item identifier (UII) defined by ISO/IEC 15459, the binary can be resolved as information having a meaning of a UII defined by ISO/IEC 15459.

Even when there isn't any information about what the binary means, the binary can have a meaning in a system using the binary. For example, an electronic product code (EPC) system can assume that all binary that are processed are EPC codes. Accordingly, the EPC system resolves the binary, which is read from a tag written according to a predetermined rule, as EPC codes.

The above will be described in detail with reference to an example of binary bit string having a 64 bit code, i.e., 10000000000000010110011010000000000000000000 00000000000000000001. This code can be resolved only when there is additional information about the type or form of the code. When there is additional information that the code is defined by ISO/IEC 11784, or a system processing the code only processes ISO/IEC 11784, the code can be resolved as follows.

The binary bit string 1.00000000000000.1.0110011010.00000000000000000000 00000000000000001 is resolved as “this tag is for identifying an animal, there are other data after this code, the code is used in Korea, and a serial number is 1”. Meanwhile, examples of the system processing the code include an RFID reader, software related to the RFID reader, a server for resolving a code, etc.

Currently, various codes exist worldwide, and an mCode, which is an exclusive code system for a mobile RFID service, is used in Korea. Japan uses their local code system, i.e., a uCode. ISO defines various code systems, not only for product management, but for other purposes. Also, for an efficient realization of an RFID system, ISO has separately established standards such as ISO/IEC 15961 and 15962 in order to provide a data form and an application interface for reading and resolving codes. An object identifier (OID) and a code are recorded in a storage medium used in the RFID system. Accordingly, the RFID system can convert meaningless binary data into meaningful information by using information about OID.

For example, in the RFID system using ISO/IEC 15961 and 15962, a tag is recorded in a code in the form P+OID+O. Here, P is a precursor used for describing a structure of OID and O, and O denotes an object that indicates an actual code. Meanwhile, OID indicates what information is contained in O.

Codes used in an RFID should able to be uniquely resolved. However, whether the binary can be uniquely resolved depends on the particular situation. That is, it is not guaranteed that the binary can be uniquely resolved only using the binary itself. In this regard, an example is given below in which reference is made to code A and code B.

Code A: 100000000000000101100110100000000000000000000000000000000 0000001

Code B: 100000000000000101100110100000000000000000000000000000000 0000001

The code A and the code B are identical, and have the same binary bit string. In order to resolve codes A and B, additional information is required. For example, let's say that the code A complies with ISO/IEC 11784 and the code B is an mCode, which is a mobile RFID exclusive code.

When the code A is generated to conform to the ISO/IEC 11784 code system, the code A should be resolved as 1 00000000000000 1 0110011010 000000000000000000 00000000000000000001, and when the code B is generated to conform to the mCode code system, the code B should be resolved as 100000000000 0001 0110011010000000 00000000000000000000000000000001. That is, the code B means that “a top level code (TLC) is 800_{HEX}, the code B is a Class B having 64 bits, a company code (CC) is 6680_{HEX}, and an item code (IC) is 1_{HEX}”. Here, the code A can uniquely identify an animal to which the tag is attached in an application for animal management, and the code B can uniquely identify online content corresponding to something to which the tag is attached in a mobile RFID service. That is, the uniqueness of the RFID code means that the RFID code is unique in a certain system and can be resolved in that system only. For example, a code used in an application dealing with airline baggage can only be resolved in an airline baggage application field. Further, it is impossible to identify the type or system of a code based on the length or pattern of the code.

Thus, a method of obtaining the type or system of a code using an OID, instead of the code itself is used in the present invention.

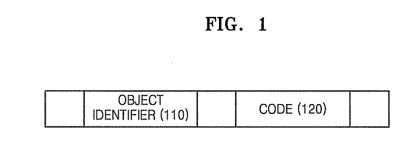

FIG. 1 is a diagram illustrating a structure of a storage medium according to an embodiment of the present invention. Any storage medium, such as an electronic tag, etc., having recorded thereon an OID 110 and a code 120 can be applied in the current embodiment of the present invention.

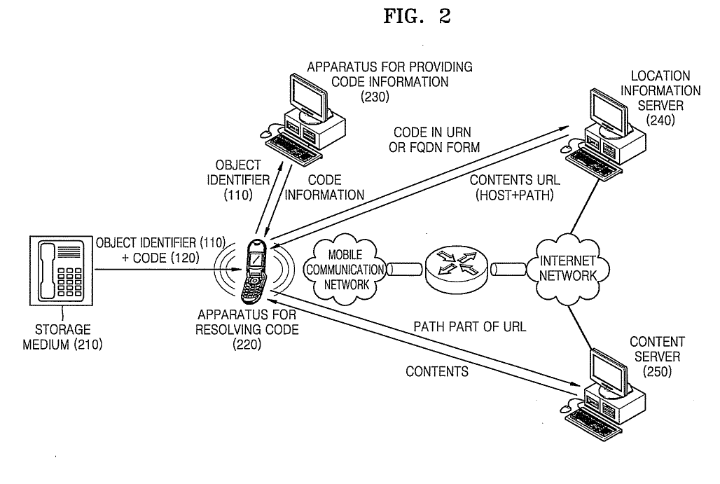

FIG. 2 is a conceptual diagram illustrating processes of resolving a code according to an embodiment of the present invention. The processes are performed using a storage medium 210, an apparatus for resolving a code 220, an apparatus for providing code information 230, a location information server 240, and a content server 250.

The apparatus for resolving a code 220 resolves an OID 110 and a code 120 by reading the OID 110 and the code 120 recorded on the storage medium 210 attached to an object through various methods, such as wire/wireless communication, a camera, or the like. Here, an example of the apparatus for resolving a code 220 is an RFID reader, a bar code reader, or the like. Based on the result of resolving the code 120, the apparatus for resolving a code 220 generates a query message requesting location information of content corresponding to the code 120 that are read. The generated query message is provided to the location information server 240. Meanwhile, when the code 120 that are read cannot be resolved by the apparatus for resolving a code 220 due to the reasons described above, the read OID 110 is transmitted to the apparatus for providing code information 230 via wire/wireless communication. In response to the transmitted OID 110, the apparatus for providing code information 230 transmits code information, which is required to resolve a code 120 corresponding to the received OID 110, to the apparatus for resolving a code 220. Here, the resolving of a code 120 according to the current embodiment means resolving required to generate the query message. However, if the read code 120 is used in another application, the resolving of a code 120 may mean resolving information required in using that application. Similarly, an example of the code information according to the current embodiment may be information required to generate the query message, but when the read code 120 is used in another application, the code information may be information required in using that application. Detailed examples of the code information include a code system required to generate the query message and a code type required to generate the query message, but since the code information can differ based on the application, they are not limited thereto. Specifically when the query message is a uniform resource name (URN) form or a fully qualified domain name (FQDN) form, the code information may be information required in converting the read code 120 into a URN or a FQDN. Meanwhile, the transmitted code information may be in an extensible markup language (XML) form, and the apparatus for providing code information 230 may be formed hierarchically, such as a domain name system (DNS) server.

Upon receiving the code information, the apparatus for resolving a code 220 resolves the read code 120 based on the code information, and generates a query message. Then the apparatus for resolving a code 220 transmits the generated query message to the location information server 240.

The location information server 240 transmits a response message containing location information of content corresponding to the read code 120 to the apparatus for resolving a code 220, in response to the received query message.

Here, examples of the location information include a uniform resource locator (URL), a uniform resource identifier (URI), and various other addresses, and examples of the location information server 240 include a DNS server, but are not limited thereto.

Upon receiving the response message, the apparatus for resolving a code 220 obtains content from the content server 250 based on the location information.

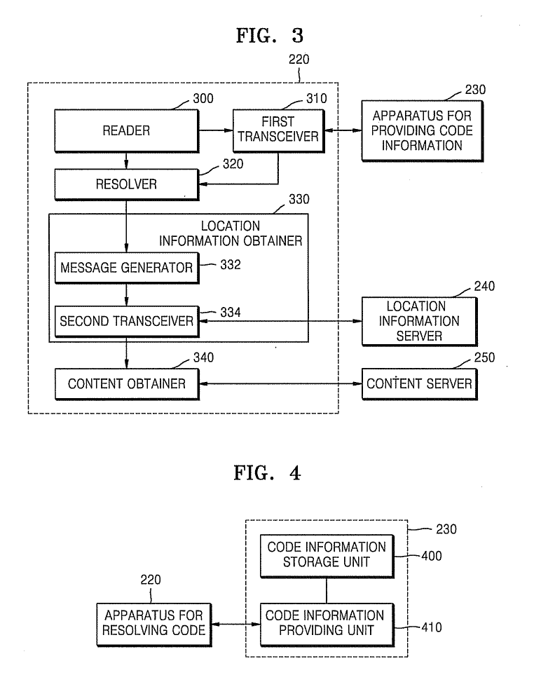

FIG. 3 is a block diagram illustrating the apparatus for resolving a code 220 illustrated in FIG. 2 according to an embodiment of the present invention. Referring to FIG. 3, the apparatus for resolving a code 220 includes a reader 300, a first transceiver 310, a resolver 320, a location information obtainer 330, and a content obtainer 340.

The reader 300 reads an OID and a code from a storage medium, such as an RFID tag.

The first transceiver 310 transmits information about the read OID, and receives code information required to resolve the code provided in response to the transmitted information. Here, examples of the code information include information about the form or type of the read code and information required to generate a query message requesting location information of content corresponding to the read code.

The resolver 320 resolves the read code based on the received code information.

The location information obtainer 330 obtains the location information of the content corresponding to the code, based on the resolved code. Meanwhile, the location information obtainer 330 includes a message generator 332 and a second transceiver 334. The message generator 332 generates a query message requesting the location information of the content corresponding to the code to a location information server 240 that provides location information of contents, based on the resolved code. In order to obtain the location information, the second transceiver 334 transmits the generated query message to the location information server 240 and receives a response message in response to the query message from the location information server 240. When the form of the query message that can be recognized by the location information server 240 is a URN or FQDN form, the message generator 332 converts the resolved code into a URN or a FQDN before generating the query message.

In order to obtain content corresponding to the read code, the content obtainer 340 connects with a content server 250, etc., based on the obtained location information.

The resolver 320 and the transceiver 310 can unconditionally obtain the code information in order to resolve the read code, but when the resolver 320 can resolve a code corresponding to the read OID using preset information, the transceiver 310 does not need to obtain the code information. Accordingly, operation of the transceiver 310 can be determined based on whether the resolver 320 can resolve a code or not.

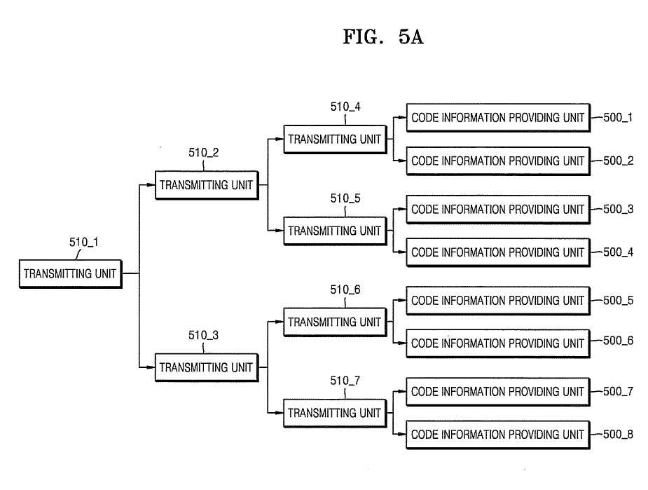

FIG. 4 is a block diagram illustrating an apparatus for providing code information 230 illustrated in FIG. 2 according to an embodiment of the present invention. Referring to FIG. 4, the apparatus for providing code information 230 includes a code information storage unit 400 and a code information providing unit 410.

The code information storage unit 400 stores code information required in resolving codes, corresponding to each OID. Here, the code information can be obtained hierarchically based on a hierarchical structure of the OID, to make searching for the stored code information is convenient.

The code information providing unit 410 extracts code information corresponding to the OID, received from an apparatus for resolving a code 220, from the code information storage unit 400 in order to provide the code information to the apparatus for resolving a code 220, or provides location information of the code information to the apparatus for resolving a code 220. As described above, examples of the code information include information about the form or type of the code and information required to generate a query message requesting location information of content corresponding to the code.

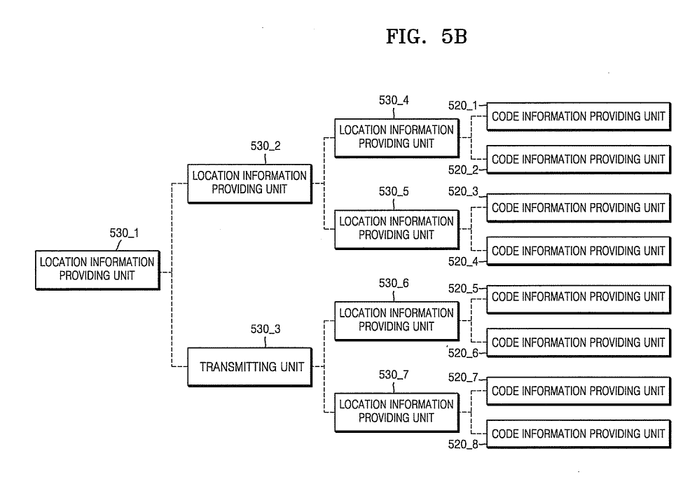

Based on the hierarchical structure of the OID, the code information storage unit 400 may include a plurality of storage units distributedly storing code information. In this case, the code information providing unit 410 hierarchically searches the plurality of storage units in order to provide the code information or the location information of the code corresponding to the received OID, based on the received OID. The code information providing unit 410 can be embodied in a server or a plurality of servers to make searching and managing of stored content efficient. FIGS. 5A and 5B show detailed embodiments of the apparatus for providing code information 230 in the above cases.

FIG. 5A is a block diagram illustrating the apparatus for providing code information 230 illustrated in FIG. 2 according to another embodiment of the present invention. The apparatus for providing code information 230 includes M code information providing units 500_1 through 500_M and L transmitting units 510_1 through 510_L. An OID is formed of N layers.

In the current embodiment, N is 3, M is 8, and L is 7, and topology is in the form of a tree, but they are not limited thereto.

Eight (8) code information providing units 500_1 through 500_8 distributedly store code information based on a hierarchical structure of the OID. For example, when the OID is 4 bits, wherein the upper bit is information about layer 1 and the next bit is information about layer 2, code information corresponding to 0000 through 0001 is stored in the code information providing unit 500_1, code information corresponding to 0010 through 0011 is stored in the code information providing unit 500_2, and code information corresponding to 1110 through 1111 is stored in the code information providing unit 500_8.

The transmitting unit 510_1 transmits the OID to one of the transmitting unit 510_2 and the transmitting unit 510_3, by selecting one of the transmitting 510_2 and the transmitting unit 510_3 based on the upper bit of the OID provided from the apparatus for resolving a code 220. The transmitting unit 510_2 transmits the OID to one of the transmitting unit 510_4 and the transmitting unit 510_5, by selecting one of the transmitting unit 510_4 and the transmitting unit 510_5 based on the second bit of the received OID. The transmitting unit 510_3 performs the same operations.

Specifically when the transmitting unit 510_5 is selected to receive the OID and the third bit of the OID is 0, the OID is transmitted to the code information providing unit 500_4. Upon receiving the OID, the code information providing unit 500_4 transmits to the apparatus for resolving a code 220 code information in which the fourth bit of the received OID is 1.

FIG. 5B is a block diagram illustrating the apparatus for providing code information 230 illustrated in FIG. 2 according to another embodiment of the present invention. The apparatus for providing code information 230 includes M code information providing units 520_1 through 520_M and L location information providing units 530_1 through 530_L. Under the same condition as the apparatus for providing code information 230 of FIG. 5A, the current embodiment will be described when an OID is 0101.

The 8 code information providing units 520_1 through 520_8 distributedly store code information based on a hierarchical structure of the OID. For example, when the OID is 4 bits wherein the upper bit is information about layer 1 and the next bit is information about layer 2, code information corresponding to 0000 through 0001 is stored in the code information providing unit 520_1, code information corresponding to 0010 through 0011 is stored in the code information providing unit 520_2, and code information corresponding to 1110 through 1111 is stored in the code information providing unit 520_8.

When the apparatus for resolving a code 220 of FIG. 2 provides the OID to the location information providing unit 530_1, the location information providing unit 530_1 selects one of the location information providing unit 530_2 and the location information providing unit 530_3 based on the upper bit of the OID, and provides location information of the selected location information providing unit 530_2 or 530_3 to the apparatus for resolving a code 220. When the OID in the above example is used, the location information of the location information providing unit 530_2 is provided.

Then, the apparatus for resolving a code 220 connects with the location information providing unit 530_2 in order to provide the OID. The location information providing unit 530_2 selects the location information providing unit 530_5, based on the second bit of the OID and provides location information of the location information providing unit 530_5 to the apparatus for resolving a code 220.

Next, the apparatus for resolving a code 220 connects with the location information providing unit 530_5 based on the provided location information in order to provide the OID. The location information providing unit 530_5 selects the code information providing unit 520_3 based on the third bit of the OID and provides location information of the code information providing unit 520_3 to the apparatus for resolving a code 220.

Then, when the apparatus for resolving a code 220 connects with the code information providing unit 520_3 based on the provided location information and provides the OID, the code information providing unit 520_3 provides code information corresponding to the OID to the apparatus for resolving a code 220.

When the OID is 1 2 410 1 and the read code is 10000000000000010110011010 00000000000000000000000000000000000001, the current embodiment is as follows. When a query message is generated by resolving the read code and the query message is in a URN form, the query message will be urn:mcode:10000000000 0.0001.0110011010000000.0000000000000000000000000000001, and when the query message is in an FQDN form, the query message will be 0000000000000000000 0000000000001.0110011010000000.0001.1000 00000000.odsr oot.or.kr. Examples of the code information include information about where to place a dot in the read code, information about adding urn:mcode, information about adding odsroot.or.kr, etc.

When it is determined that resolving the read code or generating the query message is impossible based on the read OID, the read OID is transmitted to the apparatus for providing code information 230. Finally, the apparatus for resolving a code 220 receives code information and generates the query message described above using the received code information.

The apparatus for providing code information 230 may be formed of a plurality of servers. When the apparatus for resolving a code 220 transmits the OID to a local server, the local server searches for location information of server A, i.e., a next stage server, based on the OID. Then, based on location information obtained by the searching, 129.254.15.15, the local server provides the OID to the server A, $ORIGIN 1.oidroot.or.kr.

The server A searches for location information of server B, i.e., a next stage server, based on the OID and provides the OID to the server B, $ORIGIN 2.1.oidroot.or.kr, based on location information obtained by the searching, 129.254.30.30.

The server B searches for location information of server C, i.e., a next stage server, based on the OID and provides the OID to the server C, $ORIGIN 410.2.1.oidroot.or.kr, based on location information obtained by the searching, 129.254.50.50.

The server C searches for location information of server D, i.e., a next stage server, based on the OID and provides the OID to the server D, $ORIGIN 1.410.2.1.oidroot.or.kr, based on the location information obtained by searching, 129.254.50.50.

The server D searches for code information corresponding to the OID based on the OID, and provides code information obtained by searching to the apparatus for providing code information 230.

The above described example is similar to the description of FIG. 5A, and a method of providing code information by exchanging the location information between each server and the apparatus for resolving a code 220 as illustrated in FIG. 5B can be applied in FIG. 5A as well.

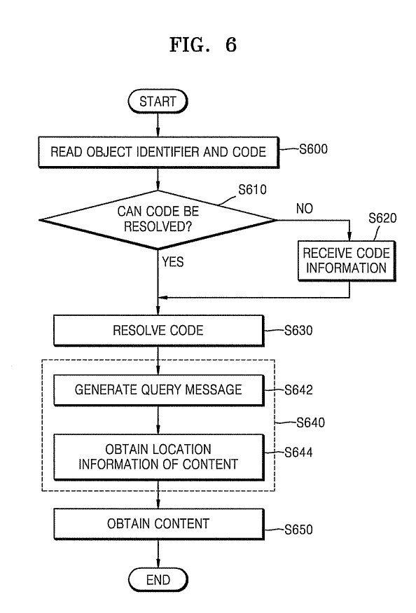

FIG. 6 is a flowchart illustrating a method of resolving a code according to an embodiment of the present invention. Referring to FIG. 6, the method is performed time sequentially in the apparatus for resolving a code 220 of FIG. 2. Accordingly, when a description is omitted, the description of the apparatus for resolving a code 220 of FIG. 2 is applied in the current embodiment.

An OID and a code are read in operation S 600.

Then, it is determined in operation S610 whether the read code can be resolved based on the read OID. When it is determined in operation S610 that the read code cannot be resolved, information about the OID is transmitted and then code information required in resolving the code, which is provided in response to the transmitted information, is received in operation S620. When it is determined in operation S610 that the read code can be resolved, the read code is resolved in operation S630. After operation S620, the read code is resolved based on the received code information in operation S630. Here, examples of the code information include information about the form or type of the code and information required in generating a query message requesting location information of content corresponding to the code.

After operation S630, the location information of content corresponding to the code is obtained based on the resolved code in operation S 640. Here, operation S640 includes operation S642 and operation S644. First, a query message requesting a location information server, which provides location information of contents, for location information of content corresponding to the code, is generated based on the resolved code in operation S642. Then, the generated query message is transmitted to the location information server and a response message in response to the query message is received from the location information server in order to obtain the location information in operation S644.

Next, content corresponding to the read code is obtained based on the obtained location information in operation S650.

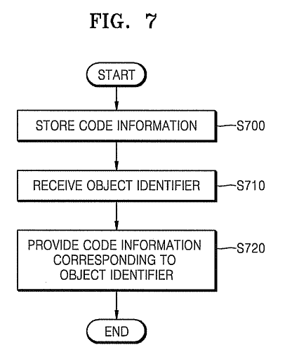

FIG. 7 is a flowchart illustrating a method of resolving a code according to another embodiment of the present invention. Referring to FIG. 7, the method is performed time sequentially in the apparatus for providing code information 230 of FIG. 2. Accordingly, when a description is omitted, the description of the apparatus for providing code information 230 of FIG. 2 is applied in the current embodiment.

Referring to FIG. 7, code information required in resolving codes corresponding to each OID is stored in operation S700. Then, the OID is received from the apparatus for resolving a code 220 of FIG. 2 in operation S710, and code information corresponding to the received OID is provided to the apparatus for resolving a code 220 in operation S720. Here, as described above, examples of the code information include information about the form or type of the code and information required in generating a query message requesting location information of content corresponding to the code.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy discs, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for resolving a code, the apparatus comprising:
a reader which reads an object identifier and a code;
a first transceiver which transmits information about the object identifier and receives code information required for resolving the code, which is provided in response to the transmitted information; and
a resolver which resolves the read code based on the received code information.

2. The apparatus of claim 1, wherein the resolver preferentially resolves the read code based on preset information, and when the resolver cannot resolve the read code based on the preset information, the first transceiver transmits the information about the object identifier and receives the code information required in resolving the code, which is provided in response to the transmitted information in order for the resolver to resolve the read code based on the received code information.

3. The apparatus of claim 1, wherein the code information comprises information about the form or type of the code.

4. The apparatus of claim 1, wherein the code information comprises information required to generate a query message requesting location information of content corresponding to the code.

5. The apparatus of claim 1, further comprising a location information obtainer which obtains location information of content corresponding to the code, based on the resolved code.

6. The apparatus of claim 5, wherein the location information obtainer comprises:
a message generator which generates a query message requesting a location information server, which provides location information of contents, for the location information of the content corresponding to the code; and
a second transceiver which transmits the generated query message to the location information server and receives a response message in response to the query message from the location information server, in order to obtain the location information.

7. The apparatus of claim 6, wherein the message generator generates the query message by converting the resolved code into a uniform resource name (URN) or a fully qualified domain name (FQDN).

8. The apparatus of claim 5, further comprising a content obtainer which obtains content corresponding to the read code based on the obtained location information.

9. An apparatus for providing code information, the apparatus comprising:
a code information storage unit which stores code information required to resolve codes, corresponding to each object identifier; and
a code information providing unit which provides code information corresponding to an object identifier received from an external device or location information of the code information with the external device.

10. The apparatus of claim 9, wherein the code information comprises information about the form or type of the code.

11. The apparatus of claim 9, wherein the code information comprises information required to generate a query message requesting location information of content corresponding to the code.

12. The apparatus of claim 9, wherein the code information storage unit comprises a plurality of storage units distributedly storing the code information based on a hierarchical structure of the object identifier.

13. The apparatus of claim 12, wherein the code information providing unit provides the code information corresponding to the received object identifier or the location information of the code by hierarchically searching the plurality of storage units, based on the received object identifier.

14. A method of resolving a code, the method comprising:
reading an object identifier and a code;
transmitting information about the object identifier and receiving code information required in resolving the code, which is provided in response to the transmitted information; and
resolving the read code based on the received code information.

15. The method of claim 14, further comprising:
determining whether the code can be resolved based on preset information;
resolving the code based on the preset information, when it is determined that the code can be resolved; and
proceeding with the transmitting of the information and the receiving of the code information, when it is determined that the code cannot be resolved.

16. The method of claim 14, wherein the code information comprises information about the form or type of the code.

17. The method of claim 14, wherein the code information comprises information required in generating a query message requesting location information of content corresponding to the code.

18. The method of claim 14, further comprising obtaining location information of content corresponding to the code, based on the resolved code.

19. The method of claim 18, wherein the obtaining of the location information of the content comprises:
generating a query message requesting a location information server, which provides location information of contents, for location information of content corresponding to the code, based on the resolved code; and
transmitting the generated query message to the location information server and receiving a response message in response to the query message from the location information server, in order to obtain the location information.

20. The method of claim 19, wherein the generating of the query message is performed by converting the resolved code into a URN or a FQDN.

21. The method of claim 18, further comprising obtaining content corresponding to the read code, based on the obtained location information.

22. A method of providing code information, the method comprising:
storing code information required in resolving codes, corresponding to each object identifier; and
providing code information corresponding to an object identifier received from an external device, to the external device.

23. The method of claim 22, wherein the code information comprises information about the form or type of the code.

24. The method of claim 22, wherein the code information comprises information required in generating a query message requesting location information of content corresponding to the code.

25. A computer readable recording medium having recorded thereon a program for executing the method of claim 14.
